(19) United States
(12) Patent Application Publication
(10) Pub. No.: US 2016/0214175 A1
(43) Pub. Date: Jul. 28, 2016

(54) Recirculating gas system for a manufacturing device.

(71) Applicant: James Nordstrom, Mountainside, NJ (US)

(72) Inventor: James Nordstrom, Mountainside, NJ (US)

(21) Appl. No.: 15/006,014

(22) Filed: Jan. 25, 2016

Related U.S. Application Data
(60) Provisional application No. 62/107,990, filed on Jan. 26, 2015.

(51) Int. Cl. B22F 3/105; B29C 67/00

(52) U.S. Cl. CPC B22F 3/1055; B29C 67/0096; B22F 2003/1059; B33Y 30/00

(57) ABSTRACT

The present invention is for a recirculating gas system for a manufacturing device. The recirculating gas system consists of an enclosure, a gas inlet, a gas outlet and an actuator to propel the gas.

### TECHNICAL FIELD

The present invention relates to a recirculating gas system for a manufacturing device.

### BACKGROUND OF THE INVENTION

An unenclosed manufacturing device exposes humans to noxious gasses, odors, fumes, ultrafine particles (UFPs), particles, noise and heat, and a part, the item a manufacturing device is creating, to varying temperatures, gas movements and humidity. This exposure can be harmful to humans and can reduce the quality of, or ruin a part.

An enclosed manufacturing device or a enclosure for a manufacturing device with a recirculating gas system can filter noxious gasses, odors, fumes, ultrafine particles (UFPs), particles, noise and heat, and improve the quality of a part by providing consistent temperatures, gas movements and humidity.

### SUMMARY OF THE INVENTION

The present invention is for a recirculating gas system for a manufacturing device. The recirculating gas system consists of an enclosure, a gas inlet, a gas outlet and an actuator to propel the gas.

### DESCRIPTION OF THE DRAWINGS

FIG. 1 is a schematic illustration of the recirculating gas system for a manufacturing device and in accordance with the invention;

FIG. 2 is a schematic illustration of the back of the recirculating gas system for a manufacturing device of FIG. 1.

FIG. 3 is a schematic illustration of the back of the recirculating gas system for a manufacturing device of FIG. 2 with the back 4 and top 3 removed

FIG. 4 is a schematic illustration of the recirculating gas system for a manufacturing device of FIG. 1 with the back 4 and top 3 removed

FIG. 5 is a schematic illustration of the bottom of the recirculating gas system for a manufacturing device of FIG. 1.

FIG. 6 is a schematic illustration of the back of the recirculating gas system for a manufacturing device of FIG. 1 that includes one or more gas attribute change devices.

### DETAILED DESCRIPTION OF THE INVENTION

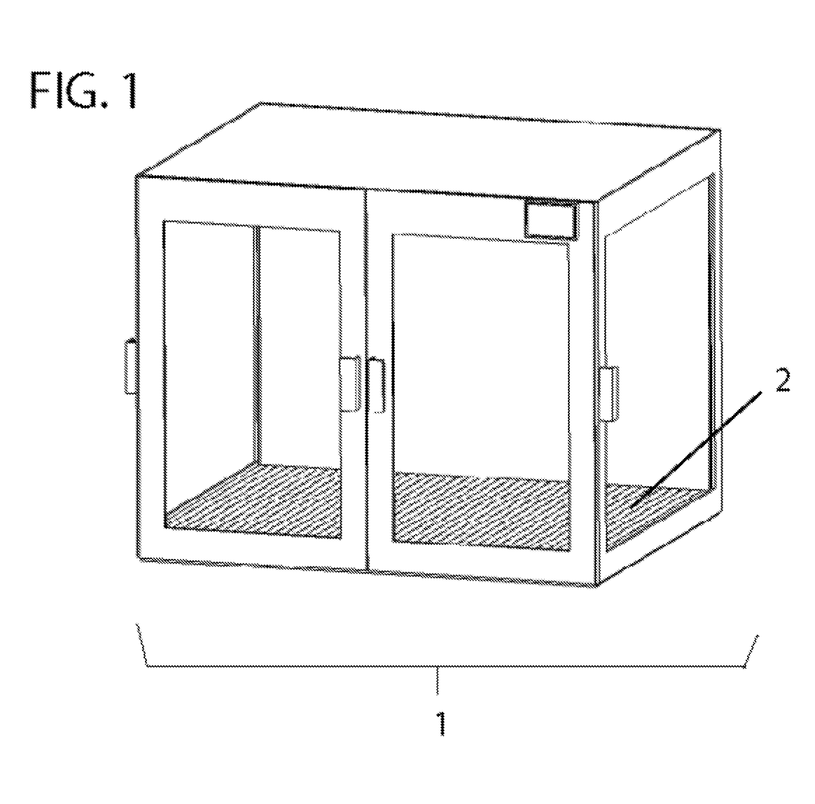

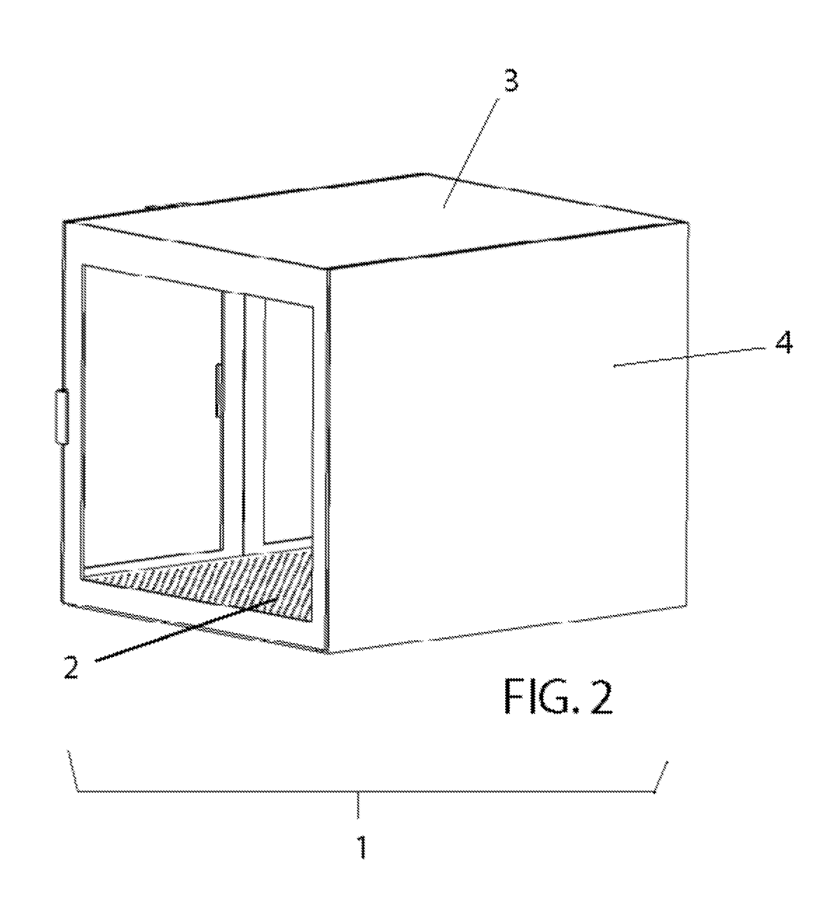

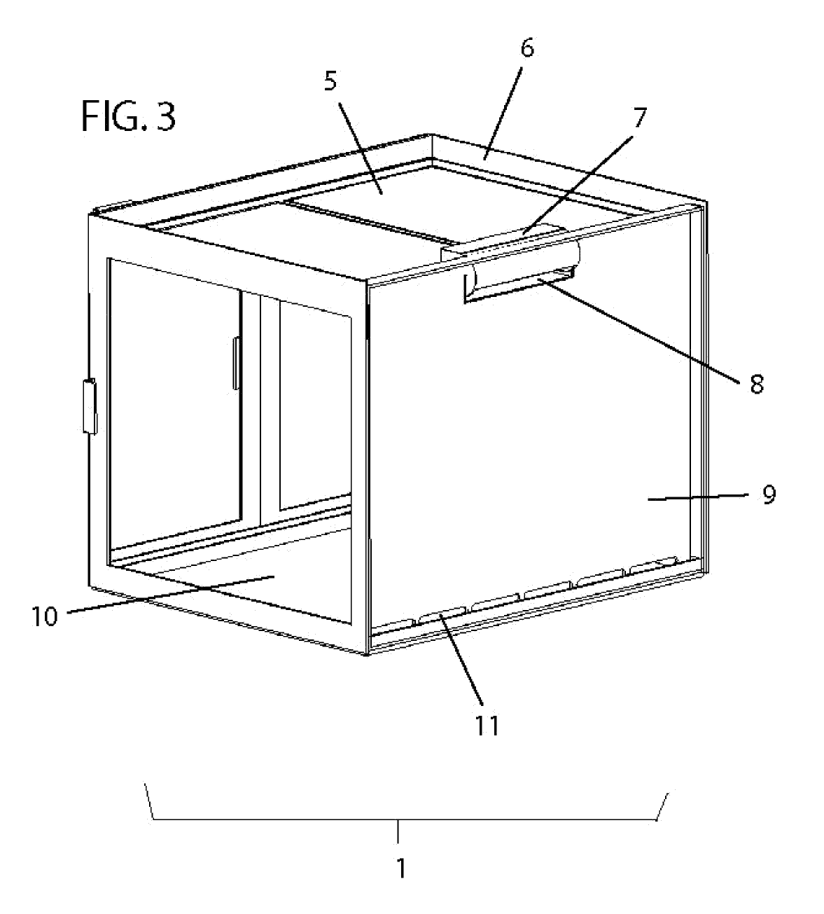

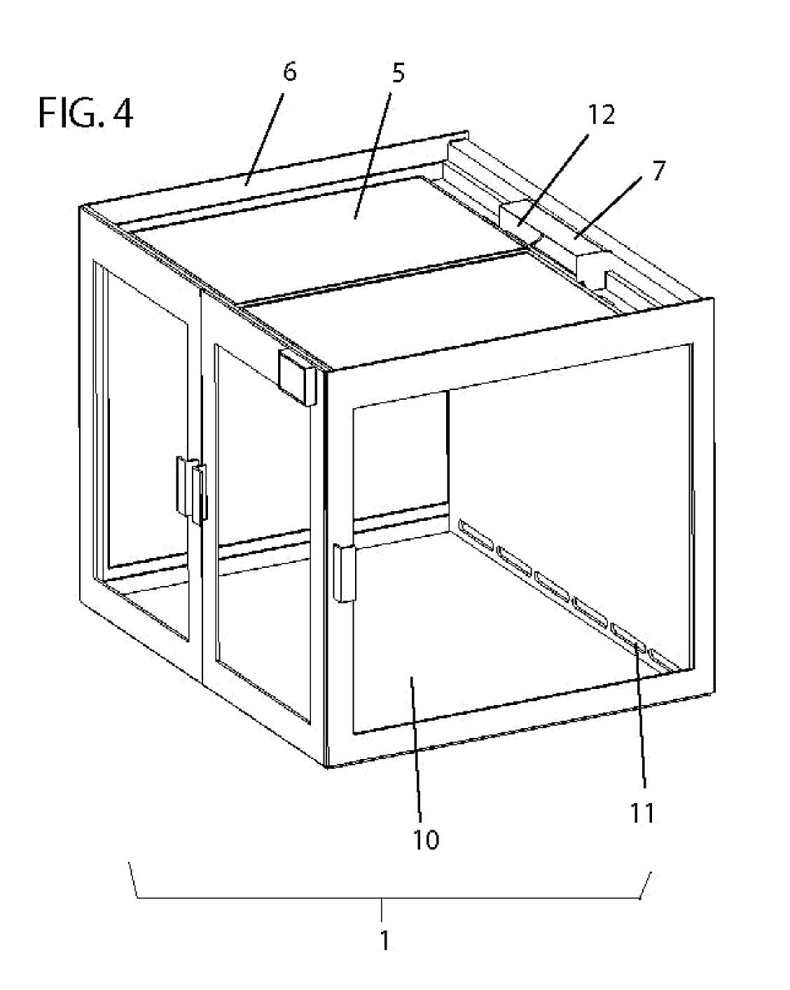

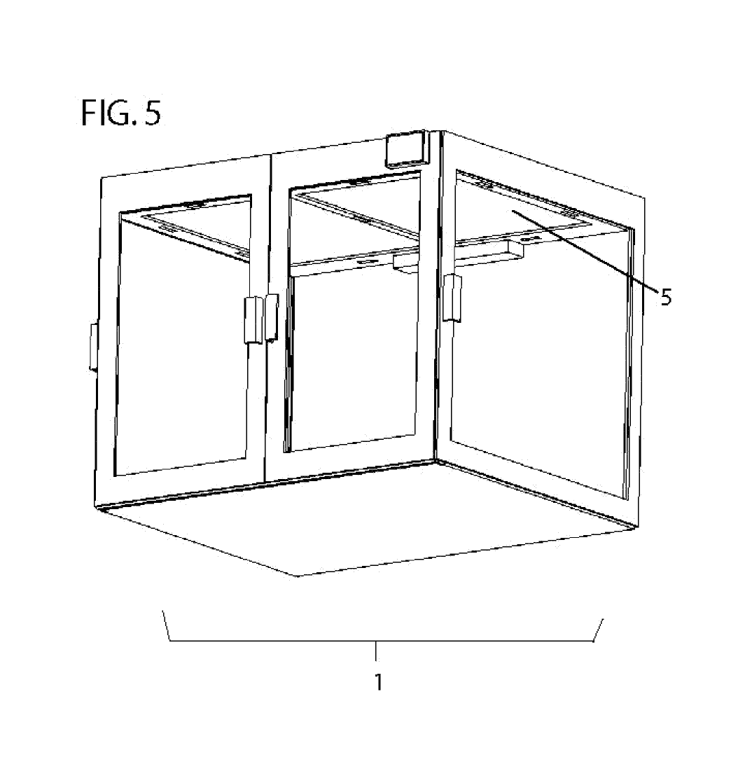

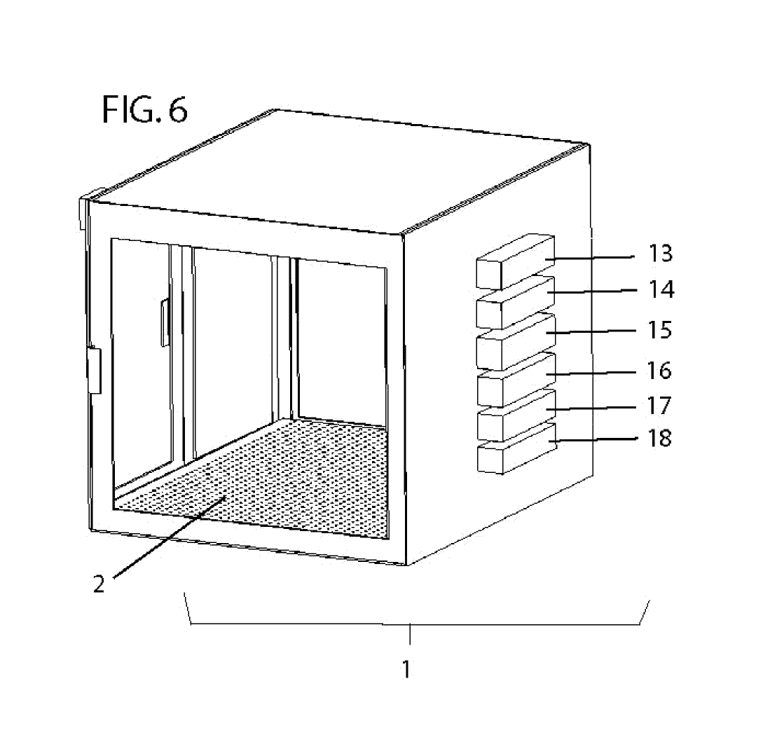

With reference to the drawings FIGS. 1, 2, 3, 4 and 5 shows the preferred embodiment of a recirculating gas system for a manufacturing device. FIG. 6 shows optional enhancements to the preferred embodiment.

The recirculating gas system for a manufacturing device of FIGS. 1, 2, 3, 4, 5 and 6 includes an enclosure 1, a gas inlet 8, a gas outlet 12, and an actuator 7 to propel the gas.

The preferred embodiment optionally uses one or more devices to change the attributes of the recirculating gas. Examples of devices that change the attributes of the recirculating gas are a filter 5, a heater 14, a humidifier 15, a dehumidifier 16 and a cooler 17. Alternative embodiments may change the recirculating gas in any number of industry standard methods.

The preferred embodiment changes the attributes of the gas by pulling the gas from the perforated bed 2 to the feed bed 10, through the inlet 11, up the rear duct 9, where the gas is optionally exposed to one or more optional devices that change the attributes of the gas, optional examples include a heater 14, a humidifier 15, a dehumidifier 16, to the inlet 8 and exits the actuator's outlet 12 where the gas enters the top duct 6, flowing through an optional filter 5, then the gas is returned to the enclosure 1, forming a recirculating gas system. An alternative embodiment pushes the gas.

The preferred embodiment may use an optional computer controller 13, to optionally control the operation and speed of the actuator 7, optional heater 14, optional humidifier 15, optional dehumidifier 16, optional cooler 17 and various optional sensors.

The preferred embodiment may use one or more optional sensors to detect temperature, gas, smoke, fire, current, voltage, particles, dust, acceleration, tilt, proximity, position, humidity and light, and power transformers, relays, solid-state relays and voltage converters in the electronic housing 18. Alternative embodiments may house the optional sensors and other electronics in any number of ways, internal or external to the enclosure 1.

The preferred embodiment optionally includes an optional electronic heater 14, Alternative embodiments may generate heat using gas, wood, oil, natural gas, solar, steam, chemical reaction or any compound or technology that is capable of generating heat.

The preferred embodiment optionally includes an optional heat pipe cooler 17, Alternative embodiments may include one or more refrigeration system, liquid nitrogen, liquid oxygen, liquid hydrogen, double pipe heat exchanger, shell and tube heat exchanger, plate heat exchanger, plate and shell heat exchanger, adiabatic wheel heat exchanger, plate fin heat exchanger, pillow plate heat exchanger, fluid heat exchangers, waste heat recovery units, dynamic scraped surface heat exchanger, HVAC gas coils, ceramic, heat sink and spiral heat exchangers or any other system, gas, compound or technology that is capable of generating cold.

In the preferred embodiment, the enclosure 1 will be constructed of sound dampening and insulating Aluminum Composite Material (ACM), alternative embodiments may be constructed from aluminum, Plexiglas, glass, wood, metal, glass, plastic or any material that can be used to construct an enclosure.

In the preferred embodiment, the enclosure 1 will be constructed from heat dissipating Aluminum Composite Material (ACM), alternative embodiments may be constructed from aluminum, Plexiglas, glass, wood, metal, glass, plastic or any material that is capable of dissipating heat.

In the preferred embodiment, parts of the enclosure 1 may be cut out and replaced with heat transferring material or heat sinks to dissipate heat.

The preferred embodiment uses a centrifugal fan actuator 7, alternative embodiments may use axial-flow, cross-flow fans or any device that is capable of propelling a gas.

The preferred embodiment uses a fan as the gas actuator 7, alternative embodiments may use compressed gas.

Gas movement is a gas propelled by an actuator.

The preferred embodiment may optionally maintain a consistent temperature within the enclosure 1.

The preferred embodiment may optionally maintain consistent humidity within the enclosure 1.

The preferred embodiment may optionally contain a thermal cutoff switch that cuts power to the manufacturing device and/or the enclosure 1, preventing equipment damage and possible fire.

In the preferred embodiment, a manufacturing device fits within the enclosure 1; alternative embodiments include a self-enclosed manufacturing device, a temporary or permanent tent, a room, or enclosed space that contains a manufacturing device and a method to recirculate a gas.

In the preferred embodiment, the enclosure 1, contains multiple access doors, alternative embodiments may include any number of doors that open in multiple ways.

In the preferred embodiment, the enclosure 1, contains multiple windows, alternative embodiments may include zero or more windows.

In the preferred embodiment, the enclosure 1, is rectangular, alternative embodiments may include enclosures of various shapes

In the preferred embodiment, the enclosure 1, is a specific size to fit a manufacturing device, alternative embodiments may vary in size.

In the preferred embodiment, the enclosure 1, does not include legs or a storage cabinet; alternative embodiments may add legs, a storage cabinet or a combination of the two.

The preferred embodiment uses the back panel 9 and top duct 6 as the duct system, alternative embodiments may use of variety of ducts.

In the preferred embodiment the gas outlet 12 uses the top duct 6 as the duct, alternative embodiments may use a side outlet, center outlet or any opening that permits gas flow.

The preferred embodiment uses Air as the operating gas, alternative embodiments may use any other gas.

The preferred embodiment recirculates the gas contained in the enclosure 1, alternative embodiments may use varying mixtures of gas contained in the enclosure and one or more external gas sources.

The preferred embodiment uses a single gas; alternative embodiments may use a mixture of gasses.

The preferred embodiment may use a variety of actuator 7 gas flow speeds to optimize human safety and/or the quality of the part being manufactured.

The preferred embodiment uses a gas at atmospheric pressure; alternative embodiments may use negative pressure to create a vacuum or increase atmospheric pressure to improve human safety and/or the quality of the part being manufactured.

The preferred embodiment uses a sealed enclosure 1, alternative embodiments may use a partially or semi sealed enclosure.

In the preferred embodiment the optional filter 5 is located in the top of the enclosure 1; alternative embodiments may locate the optional filter 5 anywhere within the gas flow. Examples include internal, external, bottom, back and sides.

In the preferred embodiment the actuator 7 is located towards the top of the enclosure 1; alternative embodiments may locate the actuator 7 anywhere within the gas flow. Examples include, internal, external, bottom, back and side.

In the preferred embodiment the optional filter 5 is large, alternative embodiments may use any number of filter sizes.

The preferred embodiment optionally reduces the amount of small, fine and ultrafine particles (UFPs) in the enclosure 1 by repeatedly filtering the gas within the enclosure 1 thought an optional filter 5. Alternative embodiments may optionally filter the gas one or more times.

The preferred embodiment optionally uses a single filter; alternative embodiments may use multiple filters.

The preferred embodiment uses HEPA and ULPA filters for the optional gas filters 5, alternative embodiments may use one or more primary filters or secondary filters; examples include: Semi HEPA, True HEPA, carbon, activated carbon, smoke, dust, pollen, mold, bacteria, carbon monoxide, carbon dioxide, nitrogen oxides, volatile organic compounds, formaldehyde, chlorine, negative-pressure, positive-pressure, chemical or any gas filtering technology.

The preferred embodiment optionally includes an LED lighting system to illuminate the manufacturing device and part, alternative embodiments may use any lighting technology or light source.

The preferred embodiment may optionally include a fire-suppression and fire control system, the enclosure 1 may contain a heat sensitive or fire triggered, fire suppression system, when the internal and or external temperature of the enclosure 1 reaches a predetermined temperature the fire suppression system will deploy inside and or outside of the enclosure. The fire suppression system can use Monoammonium phosphate Sodium bicarbonate, Potassium bicarbonate Potassium bicarbonate & Urea Complex Potassium chloride, Foam-Compatible, MET-L-KYL/PYROKYL or any device, system, liquid or gas that is capable of extinguishing a fire. Having an active fire suppression system enables the manufacturing device to operate unattended.

In the preferred embodiment the gas inlet 8 uses a perforated floor and wide filter area, alternative embodiments may use side inlets, center inlets or any opening that permits gas flow.

The preferred embodiment uses a perforated floor and large coverage outlets to create a laminar gas flow. Alternative embodiments may use a variety of configurations and gas flow patterns.

The preferred embodiment uses a single gas inlet 8; alternative embodiments may use multiple gas inlets.

The preferred embodiment uses a single gas outlet 12, alternative embodiments may use multiple gas outlet.

The preferred embodiment uses a specific size gas inlet 8, alternative embodiments may use gas inlets of various sizes and capacities.

The preferred embodiment uses a specific size gas outlet 12; alternative embodiments may use gas outlets of various sizes and capacities.

The preferred embodiment optionally includes one or more video and or still cameras to enable recording and or remote monitoring.

The preferred embodiment may optionally be monitored and operated remotely.

In the preferred embodiment the optional controller is based on the Arduino platform; alternative embodiments include Raspberry PI, PC, Mac, or any internal or remote computing device, examples include a phone, tablet, computer, laptop and or Internet enabled device.

A manufacturing device is defined as an device that is capable of manufacturing a part, this includes 3D printers, Fused deposition modelling (FDM), Electron Beam Freeform Fabrication(EBF3), Direct metal laser sintering (DMLS), Electron-beam melting (EBM), Selective laser melting (SLM), Selective heat sintering (SHS)[29], Selective laser sintering (SLS), Plaster-based 3D printing (PP), Laminated object manufacturing(LOM), Stereolithography(SLA), Digital Light Processing (DLP), 3D printers, laser cutters, plasma cutters, etching equipment, CNC machines, mechanical saws, drills, routers, sanders, additive or subtractive machining or manufacturing devices or any device that is capable of manufacturing a part.

The preferred embodiment supports PLA (Polylactic Acid), ABS (Acrylonitrile Butadiene Styrene). PRO Series PLA, PRO Series ABS, Soft PLA, LAYWOO-D3, LAYBRICK, Nylon, PVA (Polyvinyl Acetate), Bendlay, TPE, Polycarbonate (PC), High Impact Polystyrene (HIPS), ABS Filament or any other material that is capable of being 3D printed, metals, plastics, wood or any material that can be used to create a part.

The preferred embodiment uses a single actuator 7, alternative embodiments may use any number of actuators.

Some contaminates that are generated during the manufacturing of a part in a manufacturing device cannot be filtered and must be dissipated into a safe area. At the same time the quality of the part being manufactured benefits from the consistent temperatures, gas movements and humidity of the enclosure 1. The preferred embodiment may optionally include a venting system that releases these contaminates in stages or all at once. The preferred embodiment may also use a computer controller and or sensors to monitor and control the venting process.

What is claimed is:

1. A recirculating atmosphere system for a additive manufacturing device, comprising:
a. an airtight enclosure;
b. an additive manufacturing device within the enclosure;
c. at least one filter configured to capture nanoparticles generated by operation of the additive manufacturing device; and
d. an air handler configured to drive atmosphere contained within the airtight enclosure through at least one filter, and returning the atmosphere to the airtight enclosure.

2. The recirculating atmosphere system for a additive manufacturing device of claim 1, wherein the air handler is one or more of: a centrifugal pump; a compressor; a piston; a pump; a fan; and a blower.

3. The recirculating atmosphere system for a additive manufacturing device of claim 1, wherein the filter is one or more of: carbon; HEPA; activated carbon; ULPA or any common filter technology.

4. The recirculating atmosphere system for a additive manufacturing device claim 1, wherein a filter is replaceable from within or outside the additive manufacturing enclosure.

5. The recirculating atmosphere system for a additive manufacturing device claim 1, wherein the air handler is configured to drive atmosphere contained within the airtight enclosure through at least one heat exchanger, and returning the atmosphere to the airtight enclosure.

6. The recirculating atmosphere system for a additive manufacturing device claim 1, wherein the air handler is configured to drive atmosphere contained within the airtight enclosure through at least one heater, and returning the atmosphere to the airtight enclosure.

7. The recirculating atmosphere system for a additive manufacturing device claim 1, wherein the air handler is configured to drive atmosphere contained within the airtight enclosure through at least one dehumidifier, and returning the atmosphere to the airtight enclosure.

8. A additive manufacturing recirculating atmosphere system, comprising:
a. an airtight additive manufacturing device;
b. at least one filter configured to capture nanoparticles generated by operation of the additive manufacturing device; and
c. an air handler configured to drive atmosphere contained within the airtight additive manufacturing device through at least one filter, and returning the atmosphere to the airtight additive manufacturing device.

9. The additive manufacturing recirculating atmosphere system of claim 8, wherein the air handler is one or more of: a centrifugal pump; a compressor; a piston; a pump; a fan; and a blower.

10. The additive manufacturing recirculating atmosphere system of claim 8, wherein the filter is one or more of: carbon; HEPA; activated carbon; ULPA or any common filter technology.

11. The additive manufacturing recirculating atmosphere system of claim 8, wherein a filter is replaceable from within or outside the airtight additive manufacturing device.

12. The recirculating atmosphere system for a additive manufacturing device claim 8, wherein the air handler is configured to drive atmosphere contained within the airtight additive manufacturing device through at least one heat exchanger, and returning the atmosphere to the airtight additive manufacturing device.

13. The recirculating atmosphere system for a additive manufacturing device claim 8, wherein the air handler is configured to drive atmosphere contained within the airtight additive manufacturing device through at least one heater, and returning the atmosphere to the airtight additive manufacturing device.

14. The recirculating atmosphere system for a additive manufacturing device claim 8, wherein the air handler is configured to drive atmosphere contained within the airtight additive manufacturing device through at least one dehumidifier, and returning the atmosphere to the airtight additive manufacturing device.
